(19) United States
(12) Patent Application Publication
(10) Pub. No.: US 2025/0114974 A1
(43) Pub. Date: Apr. 10, 2025

(54) Apparatus For Reverse Cutting Process For Nuclear Power Plant Structure

(71) Applicant: EGUN CO., LTD., Gwangju-si (KR)

(72) Inventors: Chae Mun LEE, Gwangju-si (KR); Sung Jun LEE, Seongnam-si (KR)

(21) Appl. No.: 18/729,154

(22) PCT Filed: Jan. 18, 2023
(86) PCT No.: PCT/KR2023/000845

§ 371 Date: Jul. 15, 2024

(30) Foreign Application Priority Data
Jan. 19, 2022 (KR) 10-2022-0007871

(51) Int. Cl. B28D 1/08; B28D 7/02

(52) U.S. Cl. CPC B28D 1/08; B28D 7/02

(57) ABSTRACT

The apparatus for reverse cutting of a structure, according to the present invention, comprises a pair of reverse pulley devices, the pair of pulley devices comprising: main tubes inserted and mounted so as to penetrate two holes; a pair of first support pulleys mounted on the inner sides of the front ends of the main tubes to rotatably support a wire; a pair of second support pulleys mounted on the inner sides of the rear ends of the main tubes to rotatably support the wire; openings which are cut in portions where the two main tubes face one another and allow the wire to move; and cap covers which are coupled to the front ends of the main tubes to seal same.

### TECHNICAL FIELD

The present invention relates to a structure reverse-cutting apparatus, and more particularly to a structure reverse-cutting apparatus configured to perforate two holes in a wall of a containment building, and then to cut the wall from an outside in an inward direction using a wire saw.

### BACKGROUND ART

In general, in a task for demolition of a structure constituted by rocks, concrete, etc., a wire saw in which a plurality of diamond beads having greater hardness than that of a material constituting the structure is fitted is used. The wire saw is disposed around an outer peripheral surface of the structure to be cut such that the wire saw surrounds the structure, and a rotation force is then applied to the wire saw and, as such, the wire saw is rotated about the structure, thereby cutting the structure.

In the case in which a structure such as a wall is to be cut, two holes are perforated at the structure, and the wire saw is then inserted into the structure through the holes. In this state, a cutting task is carried out by pulling the wire saw from a rear side to a front side of the wall.

However, in the case in which a structure such as a power plant containment building is to be demolished, it is impossible to perforate two holes in a wall of the containment building, and then to perform a cutting task by pulling the wire saw from an inside to an outside of the wall through the two holes, because radiation should not leak from an interior of the containment building.

### DISCLOSURE

### Technical Problem

It is an object of the present invention to provide a structure reverse-cutting apparatus configured to perforate two holes in a wall of a containment building, and then to cut the wall from an outside in an inward direction using a wire saw, thereby preventing leakage of radiation from an interior of the containment building.

### Technical Solution

In accordance with the present invention, the above and other objects can be accomplished by the provision of a structure reverse-cutting apparatus including a pair of reverse pulley devices, wherein the pair of reverse pulley devices includes a pair of main tubes mounted through insertion thereof into two holes such that the main tubes extend through the two holes, respectively, a pair of first support pulleys respectively mounted to front end portions of the pair of main tubes within the pair of main tubes to rotatably support a wire, a pair of second support pulleys respectively mounted to rear end portions of the pair of main tubes within the pair of main tubes to rotatably support the wire, openings respectively formed facing portions of the pair of main tubes to allow movement of the wire, and cap covers respectively coupled to front ends of the pair of main tubes to seal the pair of main tubes.

The structure reverse-cutting apparatus may further include a wire supplier configured to be connected to the pair of reverse pulley devices. The wire supplier may include a driver configured to rotate the wire, and a tension adjuster configured to adjust tension of the wire. The structure reverse-cutting apparatus may further include a dust collection frame pivotably mounted to a position adjustment frame coupled to the wire supplier.

The position adjustment frame may be separably coupled to a mounting frame coupled to the wire supplier.

The structure reverse-cutting apparatus may further include a foreign matter blocking frame provided, at a peripheral edge thereof, with a rubber packing to seal a gap between the foreign matter blocking frame and a structure wall.

The foreign matter blocking frame may include a fastening plate formed with a plurality of fastening holes spaced apart from one another by a predetermined distance, and a pair of fixing plates fastened to the fastening plate in a position-adjusted state and configured to support the main tubes of the reverse pulley devices coupled thereto, respectively

The dust collection frame may be formed with a dust collection port at one side thereof. The wire supplier may further include a dust collector connected to the dust collection port by a hose to collect dust generated during a cutting task.

The dust collection frame may include a plurality of guide pulleys disposed in the dust collection frame to guide movement of the wire.

Each of the pair of the reverse pulley devices may further include a plug member separably mounted to a front end portion of a corresponding one of the openings to seal the opening and a structure wall from each other during cutting.

### Advantageous Effects

In accordance with the structure reverse-cutting apparatus of the present invention, it may be possible to prevent leakage of radiation from an interior of a containment building by perforating two holes in a wall of the containment building, and then cutting the wall from an outside in an inward direction using a wire saw.

### DESCRIPTION OF DRAWINGS

FIG. 1 is a right side view showing a nuclear plant structure reverse-cutting apparatus according to an embodiment of the present invention.

FIG. 2 is a right side view showing the nuclear plant structure reverse-cutting apparatus according to the embodiment of the present invention.

FIG. 3 is a left side view (a), a horizontal sectional view (b), and a vertical sectional view (c) showing a reverse pulley device.

FIG. 4 is a left side view (a) of a dust collection frame and a right side view (b) of a foreign matter blocking frame.

FIG. 5 is a horizontal sectional view schematically showing cutting in a vertical direction using the structure reverse-cutting apparatus of the present invention.

FIG. 6 is a right side view (a) showing cutting in a horizontal direction using the structure reverse-cutting apparatus of the present invention and a front view (b) and a right side view (c) of the reverse pulley device.

FIG. 7 is a horizontal sectional view schematically showing a nuclear plant structure reverse-cutting apparatus according to an embodiment of the present invention.

### BEST MODE

Embodiments may be variously varied and may have various forms. In connection with this, specific embodiments will be illustrated in the drawings, and will be described in detail in the specification, but embodiments should not be construed as limited to the specific embodiments. It is to be appreciated that all changes, equivalents, and substitutes that do not depart from the spirit and technical scope of the embodiments are encompassed in the embodiments.

It should be noted that the terms used herein are merely used to describe a specific embodiment, not to limit the present invention. Incidentally, unless clearly used otherwise, singular expressions include a plural meaning. In this application, the term “comprising,” “including,” or the like, is intended to express the existence of the characteristic, the numeral, the step, the operation, the element, the part, or the combination thereof, and does not exclude another characteristic, numeral, step, operation, element, part, or any combination thereof, or any addition thereto.

Hereinafter, embodiments of the present invention will be described in detail with reference to the accompanying drawings. It is noted that the same reference numerals in the drawings designate the same constituent elements, respectively. When the detailed description of the relevant known function or configuration is determined to unnecessarily obscure the gist of the present invention, the detailed description will be omitted. For similar reasons, in the accompanying drawings, a part of constituent elements is exaggerated, omitted, or schematically illustrated.

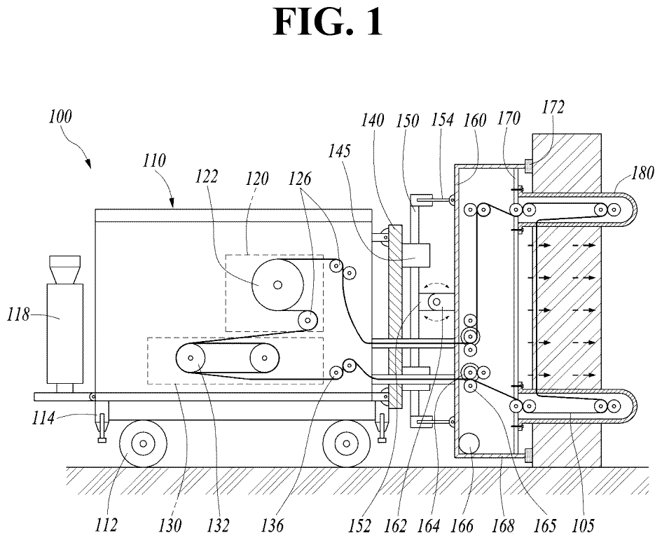

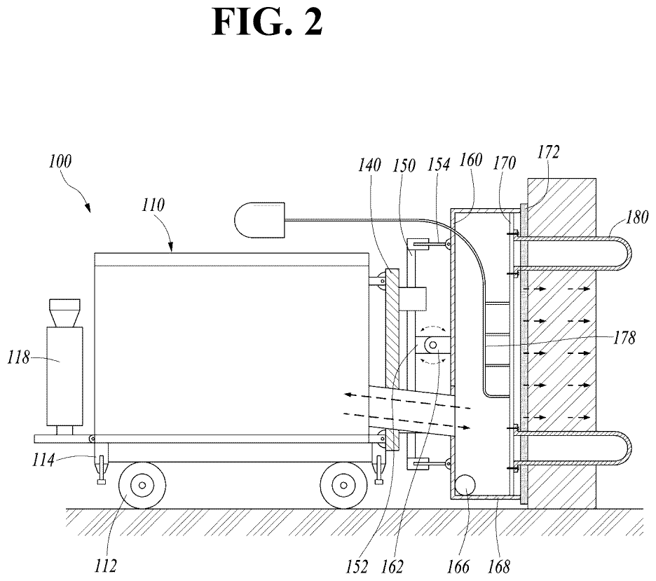

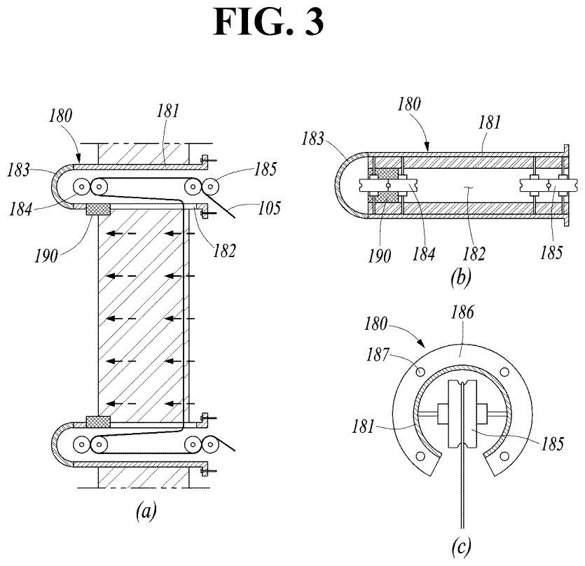

FIG. 1 is a right side view showing a nuclear plant structure reverse-cutting apparatus according to an embodiment of the present invention. FIG. 2 is a right side view showing the nuclear plant structure reverse-cutting apparatus according to the embodiment of the present invention. FIG. 3 is a left side view (a), a horizontal sectional view (b), and a vertical sectional view (c) showing a reverse pulley device.

A nuclear plant structure reverse-cutting apparatus 100 according to an embodiment of the present invention includes a body 110 provided therein with a driver 120 configured to rotate a wire 105 and a tension adjuster 130 configured to adjust tension of the wire 105, a dust collection frame 160 coupled to the body 110 such that the dust collection frame 160 tightly contacts a structure wall to surround two holes perforated at the structure wall, a foreign matter blocking frame 170 coupled to an inside of side walls of the dust collection frame 160, and a pair of reverse pulley devices 180 fastened to the foreign matter blocking frame 170 such that the reverse pulley devices 180 are inserted into the two holes, respectively. In the present invention, the wire 105 may also be referred to as a wire saw.

The pair of reverse pulley devices 180 may include a pair of main tubes 181 respectively inserted into the holes to be mounted to the holes, pairs of first support pulleys 184 mounted to insides of front end portions of the main tubes 181, respectively, to rotatably support the wire 105, and pairs of second support pulleys 185 mounted to insides of rear end portions of the main tubes 181, respectively, to rotatably support the wire 105.

Each of the main tubes 181 may be formed to have substantially a circular pipe shape. Each main tube 181 may be formed to have an outer diameter equal to or slightly smaller than an inner diameter of each hole formed at the structure wall.

Four pulley rotation shafts, to which one pair of first support pulleys 184 and one pair of second support pulleys 185 are rotatably mounted, respectively, may be coupled to an inner peripheral surface of each main tube 181. Each pair of first support pulleys 184 may be disposed at a center of the inside of the front end portion of a corresponding one of the main tubes 181 such that the first support pulleys 184 are adjacent to each other. Each pair of second support pulleys 185 may be disposed at a center of the inside of the rear end portion of a corresponding one of the main tubes 181 such that the second support pulleys 185 are adjacent to each other. The wire 105 may be wound to pass between each pair of first support pulleys 184 and between each pair of second support pulleys 185.

The pair of main tubes 181 is opened through cutting at facing portions thereof and, as such, openings 182 allowing movement of the wire 105 therethrough may be formed. Since the wire 105 moves in an inward direction from an outer surface of the structure wall during a cutting task, the wire 105 may not interfere with the pair of main tubes 181 by virtue of the openings 182.

A cap cover 183, which seals each main tube 181 from an inside of the structure wall, may be coupled to the front end of each main tube 181. The cap cover 183 substantially takes the form of a hollow hemispherical body, and coupling thereof may be achieved as threads formed on an outer circumferential surface of the cap cover 183 at one end of the cap cover 183 is fastened to threads formed at an inner circumferential surface of the front end portion of the main tube 181.

A fastening rib 186 extending radially may be integrally formed at a rear end edge of each main tube 181 while being disposed outside the main tube 181. A plurality of fastening holes is 187 formed at the fastening rib 186, and, as such, the main tube 181 may be mounted to a foreign matter blocking frame 170 through coupling by fastening fasteners such as screws or the like to the foreign matter blocking frame 170 through the fastening holes 187.

In addition, each reverse pulley device 100 may further include a plug member 190 separably mounted to a front end of a corresponding one of the openings 182 to seal the opening 182 and the structure wall from each other during cutting.

The plug member 190 may be formed of a plastic material and may be fitted in the front end of the opening 182 in a force-fitting manner. The front end of the opening 182 may communicate with an inside of the structure wall where radiation (for example, a hazardous material referred to as radiation hereinafter, for convenience of description) is present. Accordingly, the opening 182 is sealed by the plug member 190 during cutting and, as such, leakage of radiation may be minimized. The plug member 190 is a member exposed to radiation and may be partially cut by the wire 105. To this end, it is preferred that the plug member 190 be disposed of after being used as a disposable member.

Meanwhile, as shown in FIG. 2, a compressed air pipe 178 extends from an outside of the dust collection frame 160 to the foreign matter blocking frame 170 to inject compressed air toward the structure wall. The compressed air pipe 178 is connected to an air pump, and a plurality of outlet ports is arranged at an end of the compressed air pipe 178 and, as such, may uniformly inject compressed air toward the structure wall. The compressed air may be injected in accordance with operation of a remote switch connected to the air pump. The compressed air injected in the above-described manner may dissipate heat generated by the wire 105, etc., and may enhance dust collection performance of a dust collector 118 which will be described later.

The pair of reverse pulley devices 180 may have a structure coupled to the foreign matter blocking frame 170 and spaced apart from the foreign matter blocking frame 170 by a predetermined distance at front ends thereof while having a structure coupled to a wire supplier 110 at rear ends thereof.

The wire supplier 110 (typically, a configuration corresponding to a body in a wire saw apparatus) includes a case in which the driver 120 and the tension adjuster 130 may be mounted. A caterpillar wheel 112 or a plurality of wheels is provided at a lower portion of the wire supplier 110 and, as such, the wire supplier 110 is movable in a self-propelled manner by an engine or a motor. In addition, four stretchable fixing legs 114 are provided at the lower portion of the wire supplier 110 and, as such, the wire supplier 110 may be fixed by the four fixing legs 114 not to be moved or overturned after being moved to a particular position by the caterpillar wheel 112.

The driver 120 may be configured through inclusion of a drive pulley 122 configured to be rotated by a motor, thereby rotating the wire 105 guided by a plurality of guide pulleys 126. The motor, which rotates the wire 105 at a high speed, may be constituted by a hydraulic motor.

The tension adjuster 130 may maintain the wire 105 connected to the driver 120 in a tensioned state. For this function, the tension adjuster 130 may include a separate motor configured to move a plate mounted with a pair of movable pulleys 132 in a forward/rearward direction. Each of the movable pulleys 132 is formed with a plurality of grooves at a circumferential surface thereof and, as such, the wire 105 may be wound two or more turns between the two movable pulleys 132. The wire 105 exiting the tension adjuster 130 may be guided to an outside of the case of the wire supplier 110 by guide pulleys 136.

The dust collection frame 160 may be coupled to the wire supplier 110 to tightly contact the structure wall while surrounding the two holes perforated at the structure wall. The dust collection frame 160 may have a rectangular box shape opened at a front surface thereof to tightly contact the structure wall. Accordingly, the dust collection frame 160 may have four side walls 168. A rear surface of the dust collection frame 160 may be connected to a front surface of the wire supplier 110 and, as such, may be supported by the wire supplier 110. The dust collection frame 160 may be brought into tight contact with the structure wall, thereby sealing an inner space during a cutting task.

The foreign matter blocking frame 170 is mounted to inner surfaces of the side walls 168 of the dust collection frame 160 through coupling. The pair of reverse pulley devices 180 may be coupled to the foreign matter blocking frame 170 and, as such, may be supported by the foreign matter blocking frame 170.

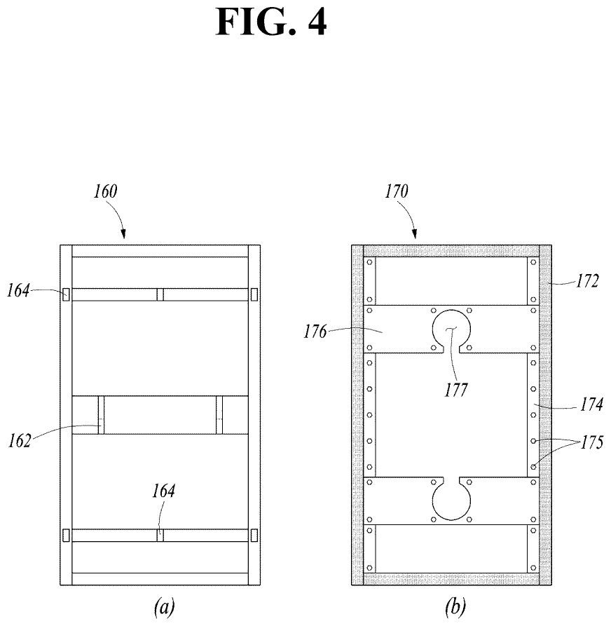

FIG. 4 is a left side view (a) of the dust collection frame and a right side view (b) of the foreign matter blocking frame.

As shown in FIG. 1, the dust collection frame 160 may be pivotably mounted to a position adjustment frame 150 coupled to the wire supplier 110. For this configuration, as shown in FIG. 4(a), a plurality of pivot ribs 162 may be provided at the rear surface of the dust collection frame 160. A plurality of pivot ribs 152 may be provided at a front surface of the position adjustment frame 150 to be pivotably connected to the plurality of pivot ribs 162 of the dust collection frame 160 by pivot pins.

In addition, as shown in FIG. 4(a), a plurality of cylinder connection ribs 164 may be provided at the rear surface of the dust collection frame 160 and, as such, tight-contact adjustment cylinders 154 may be connected between the dust collection frame 160 and the position adjustment frame 150. The plurality of tight-contact adjustment cylinders 154 is configured to be stretchable and, as such, may bring a peripheral edge of the dust collection frame 160 into tight contact with a surface of the structure wall by adjusting a disposition angle of the dust collection frame 160 with respect to the position adjustment frame 150. The plurality of cylinder connection ribs 164 may include four cylinder connection ribs 164 respectively provided at upper and lower portions of left and right edges of the dust collection frame 160 to enable the pair of reverse pulley devices 180 to be disposed at left and right sides, respectively, and two cylinder connection ribs 164 respectively centrally provided at the dust collection frame 160 in a left/right direction to enable the pair of reverse pulley devices 180 to be disposed at upper and lower sides, respectively.

As shown in FIG. 1, the position adjustment frame 150 may be separably coupled to a mounting frame 140 coupled to the wire supplier 110. The mounting frame 140 may be provided, at a rear surface thereof, with a plurality of mounting ribs configured to be fastened to the front surface of the wire supplier 110 by fasteners such as bolts and nuts. A plurality of coupling ribs 145, to which the position adjustment frame 150 is coupled, may be formed at a front surface of the mounting frame 140. The plurality of coupling ribs 145 of the mounting frame 140 may be coupled to the position adjustment frame 150 through fastening of fasteners. Alternatively, the mounting frame 140 may be integrally connected to the position adjustment frame 150 through welding.

Meanwhile, as shown in FIG. 4(b), the foreign matter blocking frame 170 may be provided, at a peripheral edge thereof, with a rubber packing 172 to seal a gap between the foreign matter blocking frame 170 and the structure wall. The rubber packing 172 may be mounted along the peripheral edge of the foreign matter blocking frame 170, that is, front ends of the side walls 168 of the dust collection frame 160 and, as such, may be pressed onto the structure wall, thereby sealing the gap between the foreign matter blocking frame 170 and the structure wall.

In addition, the foreign matter blocking frame 170 may include a fastening plate 174 formed with a plurality of fastening holes 175 spaced apart from one another by a predetermined distance, and a pair of fixing plates 176 fastened to the fastening plate 174 in a position-adjusted state and configured to support the main tubes 181 of the reverse pulley devices 180 coupled thereto, respectively.

The fastening plate 174 may take the form of a pair of ribs respectively extending inwards from opposite sides of the foreign matter blocking frame 170. Since the fastening holes 175 are formed at the fastening plate 174 while being spaced apart from one another by the predetermined distance, it may be possible to fasten opposite lateral ends of each fixing plate 176 to selected ones of the fastening holes 175 of the fastening plate 174 at a selected position by screws. Openings 177 corresponding to respective main tubes 181 of the reverse pulley devices 180 may be formed at central portions of the pair of fixing plates 176, respectively. The two openings 177 may be opened in facing directions, corresponding to the openings 182 of the main tubes 181, respectively. Fastening holes corresponding to t the fastening holes 187 formed at the fastening rib 186 of each main tube 181 may be formed around each opening 177.

In addition, as shown in FIG. 1, the dust collection frame 160 may be formed with a dust collection port 166 at one side thereof, and the wire supplier 110 may further include a dust collector 118 connected to the dust collection port 166 by a hose and configured to collect dust generated during a cutting task.

When the dust collection frame 160 is brought into tight contact with the surface of the structure wall, the inner space of the dust collection frame 160 may be sealed from an exterior. When a cutting task is carried out through rotation of the wire 105, a large amount of dust may be generated. To this end, the dust collection port 166 may be formed at one side wall of the dust collection frame 160, and may be connected to the dust collector 118 through a flexible hose. The dust collector 118 may be mounted to an outside of the case of the wire supplier 110, and may be equipped with a suction motor therein. Accordingly, the dust collector 118 may collect dust after separating the dust from air sucked from the inner space of the dust collection frame 160, and may then discharge only clean air.

As shown in FIG. 1, the dust collection frame 160 may include a plurality of guide pulleys 165 disposed in the dust collection frame 160 and configured to guide movement of the wire 105. Since the wire 105 rotates in a state in which very great tension is applied thereto, the guide pulleys 165 are provided in an area where the wire 105 is bent and, as such, the wire 105 may be smoothly driven. In addition, since the wire 105 extends to the interior of the case of the wire supplier 110 after passing through the dust collection frame 160, the position adjustment frame 150, and the mounting frame 140, a pair of guide tubes configured to guide movement of the wire 105 from the dust collection frame 160 to the case of the wire supplier 110 may be disposed.

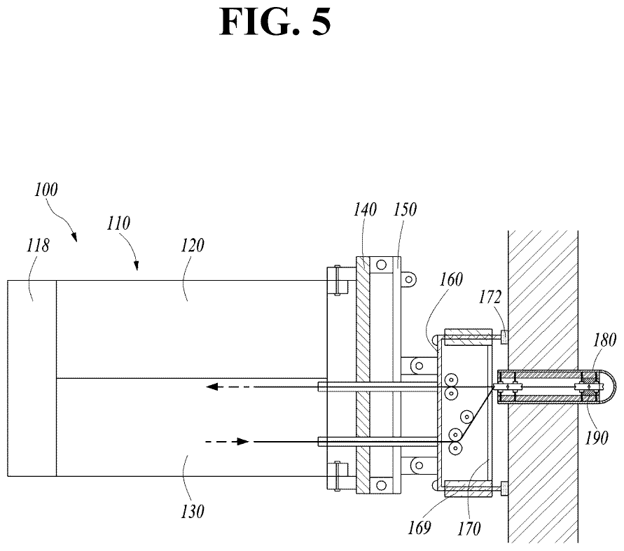

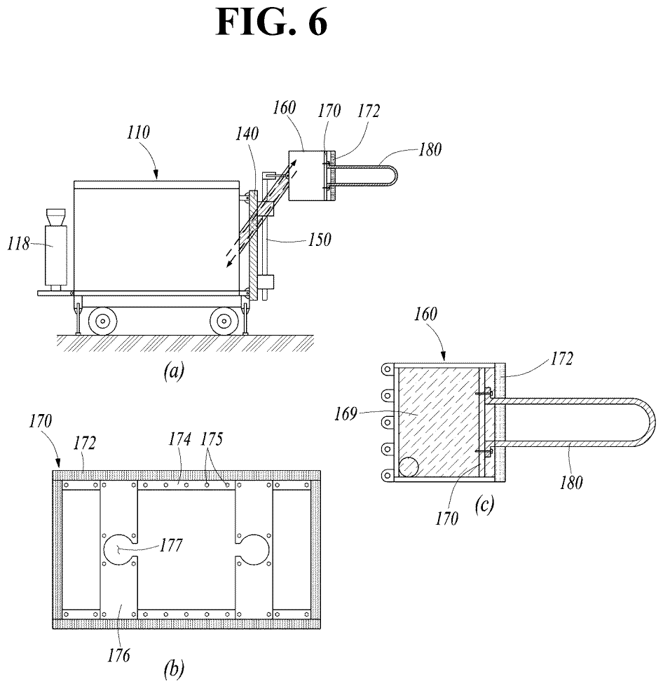

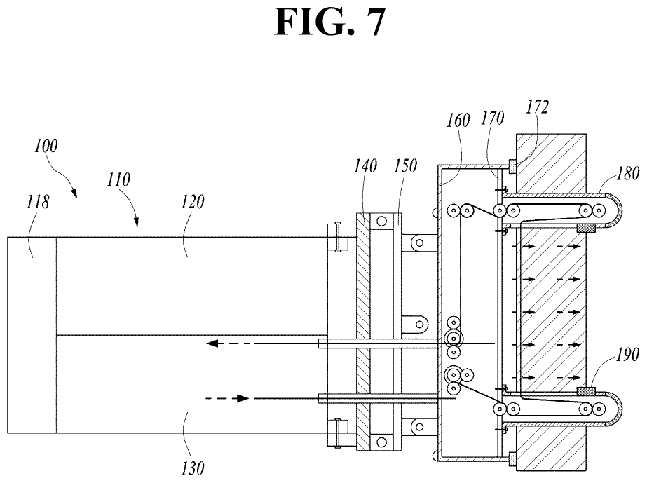

FIG. 5 is a horizontal sectional view schematically showing cutting in a vertical direction using the structure reverse-cutting apparatus of the present invention. FIG. 6 is a right side view (a) showing cutting in a horizontal direction using the structure reverse-cutting apparatus of the present invention and a front view (b) and a right side view (c) of the reverse pulley device. FIG. 7 is a horizontal sectional view schematically showing a structure reverse-cutting apparatus according to an embodiment of the present invention.

As shown in FIG. 5, cutting in a vertical direction may be performed using the structure reverse-cutting apparatus of the present invention by inserting the reverse pulley devices 180 into two holes perforated at upper and lower positions, respectively. In this case, the dust collection frame 160 may be coupled to the position adjustment frame 150 in a state in which the two reverse pulley devices 180 are disposed at upper and lower sides, respectively.

As shown in FIG. 6, cutting in a horizontal direction may be performed using the structure reverse-cutting apparatus of the present invention by inserting the reverse pulley devices 180 into two holes perforated at left and right positions, respectively. In this case, the dust collection frame 160 may be coupled to the position adjustment frame 150 in a state in which the two reverse pulley devices 180 are disposed at left and right sides, respectively.

FIG. 7 is a sectional view horizontal corresponding to the right side view of FIG. 1. The structure reverse-cutting apparatus 100 shown in FIG. 7 is slightly different from that of FIG. 1 in terms of disposition of the guide pulleys 165 in the dust collection frame 160 while being slightly different from that of FIG. 1 in terms of a coupling structure between the case of the wire supplier 110 and the mounting frame 140, a coupling structure between the mounting frame 140 and the position adjustment frame 150, and a coupling structure between the position adjustment frame 150 and the dust collection frame 160. The structure reverse-cutting apparatus of the present invention may also include variants of FIG. 7.

Although the present invention has been described with reference to the above-mentioned preferred embodiments, the present invention may be modified and varied through addition, modification, deletion, etc. of constituent elements without departing from the technical ideas of the present invention. Therefore, it is intended that the present invention embraces such modification and variation as fall within the scope of the present invention.

### DESCRIPTION OF REFERENCE NUMERALS

100: structure reverse-cutting apparatus 105: wire
110: wire supplier 112: caterpillar wheel
114: fixing leg 118: dust collector
120: driver 122: drive pulley
126: guide pulley
130: tension adjuster 132: movable pulley
136: guide pulley
140: mounting frame 145: coupling rib
150: position adjustment frame 152: pivot rib
154: tight-contact adjustment cylinder
160: dust collection frame 162: pivot rib
164: cylinder connection rib 165: guide pulley
166: dust collection port 168: side wall
169: transparent cover
170: foreign matter blocking frame 172: rubber packing
174: fastening plate 175: fastening hole
176: fixing plate 177: opening
178: compressed air pipe
180: reverse pulley device 181: main tube
182: opening 183: cap cover
184: first support pulley 185: second support pulley
186: fastening rib 187: fastening hole
190: plug member

### Industrial Applicability

The nuclear plant structure reverse-cutting apparatus according to the present invention is industrially applicable to nuclear plant structure demolition sites, etc.

1. A structure reverse-cutting apparatus comprising:
a pair of reverse pulley devices,
wherein the pair of reverse pulley devices comprises:
a pair of main tubes mounted through insertion thereof into two holes such that the main tubes extend through the two holes, respectively;
a pair of first support pulleys respectively mounted to front end portions of the pair of main tubes within the pair of main tubes to rotatably support a wire;
a pair of second support pulleys respectively mounted to rear end portions of the pair of main tubes within the pair of main tubes to rotatably support the wire;
openings respectively formed facing portions of the pair of main tubes to allow movement of the wire; and
cap covers respectively coupled to front ends of the pair of main tubes to seal the pair of main tubes.

2. The structure reverse-cutting apparatus according to claim 1, further comprising:
a wire supplier configured to be connected to the pair of reverse pulley devices,
wherein the wire supplier comprises:
a driver configured to rotate the wire; and
a tension adjuster configured to adjust tension of the wire.

3. The structure reverse-cutting apparatus according to claim 2, further comprising:
a dust collection frame pivotably mounted to a position adjustment frame coupled to the wire supplier.

4. The structure reverse-cutting apparatus according to claim 3, wherein the position adjustment frame is separably coupled to a mounting frame coupled to the wire supplier.

5. The structure reverse-cutting apparatus according to claim 1, further comprising:
a foreign matter blocking frame provided, at a peripheral edge thereof, with a rubber packing to seal a gap between the foreign matter blocking frame and a structure wall.

6. The structure reverse-cutting apparatus according to claim 5, wherein the foreign matter blocking frame comprises:
a fastening plate formed with a plurality of fastening holes spaced apart from one another by a predetermined distance; and
a pair of fixing plates fastened to the fastening plate in a position-adjusted state and configured to support the main tubes of the reverse pulley devices coupled thereto, respectively.

7. The structure reverse-cutting apparatus according to claim 3, wherein:
the dust collection frame is formed with a dust collection port at one side thereof; and
the wire supplier is connected to the dust collection port by a hose to collect dust generated during a cutting task.

8. The structure reverse-cutting apparatus according to claim 3, wherein the dust collection frame comprises a plurality of guide pulleys disposed in the dust collection frame to guide movement of the wire.

9. The structure reverse-cutting apparatus according to claim 1, wherein each of the pair of the reverse pulley devices further comprises a plug member separably mounted to a front end portion of a corresponding one of the openings to seal the opening and a structure wall from each other during cutting.

10. The structure reverse-cutting apparatus according to claim 1, wherein the structure reverse-cutting apparatus comprises a power plant structure reverse-cutting apparatus.
